(19) United States
(12) Patent Application Publication
(10) Pub. No.: US 2007/0013161 A1
(43) Pub. Date: Jan. 18, 2007

(54) Variable-stiffness vehicle suspension system

(76) Inventor: Jacky Rhein, Yerres (FR)

Correspondence Address: CONNOLLY BOVE LODGE & HUTZ LLP, P.O. BOX 2207, WILMINGTON, DE, 19899-2207, US

(21) Appl. No.: 10/575,166

(22) PCT Filed: Oct. 11, 2004
(86) PCT No.: PCT/FR04/02572

§ 371 Date: Apr. 10, 2006

(30) Foreign Application Priority Data
Oct. 9, 2003 (FR) 0311813

(51) Int. Cl. B60G 9/00

(52) U.S. Cl. 280/124.162

(57) ABSTRACT

A vehicle suspension including a coil spring mounted between two supports of variable spacing. At least one of the ends of the spring (13) bears against one of the supports (14, 15) via an elastically deformable bushing (17) of variable stiffness.

The invention relates to a vehicle suspension of variable stiffness, and it relates more particularly to an improvement applied to a subassembly of such a suspension, as constituted by a spring mounted to bear against two supports.

In certain suspension systems, in particular for cars, use is made of variable-stiffness springs, both to obtain acceptable comfort under light loading and to guarantee a minimum force between bearing points when the suspension is in the relaxed position (when the wheel is hanging). This minimum force is essential to ensure that the spring is held between the two supports between which it is installed.

Unfortunately, a variable-stiffness spring of the coil type can be quite complicated in structure and consequently expensive to manufacture.

For example, it may be necessary to shape such a coil spring so that at least one end portion thereof presents a different pitch or presents turns of continuously varying diameter in a helix so as to allow said turns to become engaged in one another without coming into contact with abutments. In this context, the invention makes it possible at least to simplify spring design and consequently to make a spring easier and less expensive to produce. Advantageously, the invention makes it possible in numerous suspension configurations to make use of coil springs that are very simple to produce, i.e. springs of constant stiffness.

More particularly, the invention relates to a vehicle suspension comprising a coil spring mounted between two supports of variable spacing, the suspension being characterized in that at least one of the ends of said spring bears against a corresponding one of said supports via an elastically deformable bushing of variable stiffness and presenting significant variation in stiffness, said bushing being secured to the corresponding support.

The term “significant variation in stiffness” is used to mean that the bushing acts effectively in varying the overall stiffness of the complete subassembly (spring and bushing(s)). The mean stiffness of such a bushing is thus of the same order of magnitude as that of the spring, although in most cases it is significantly smaller in order to act over at least a portion of the deflection stroke of the subassembly. In particular, such bushings are advantageous for giving a particular configuration to the variation in the stiffness of the subassembly when under light loading.

As mentioned above, said spring may be of the constant stiffness type.

Advantageously, a said bushing is interposed between each said support and the corresponding end turn of said spring.

In one possible embodiment, said bushing comprises a thick annular base of elastomer material or the like, that is elastically deformable. The variation in the stiffness of the bushing can thus depend in part on its shape. For example, the base may include an annular recess.

The invention can be better understood and other advantages thereof appear better in the light of the following description given purely by way of example and made with reference to the accompanying drawing, in which:

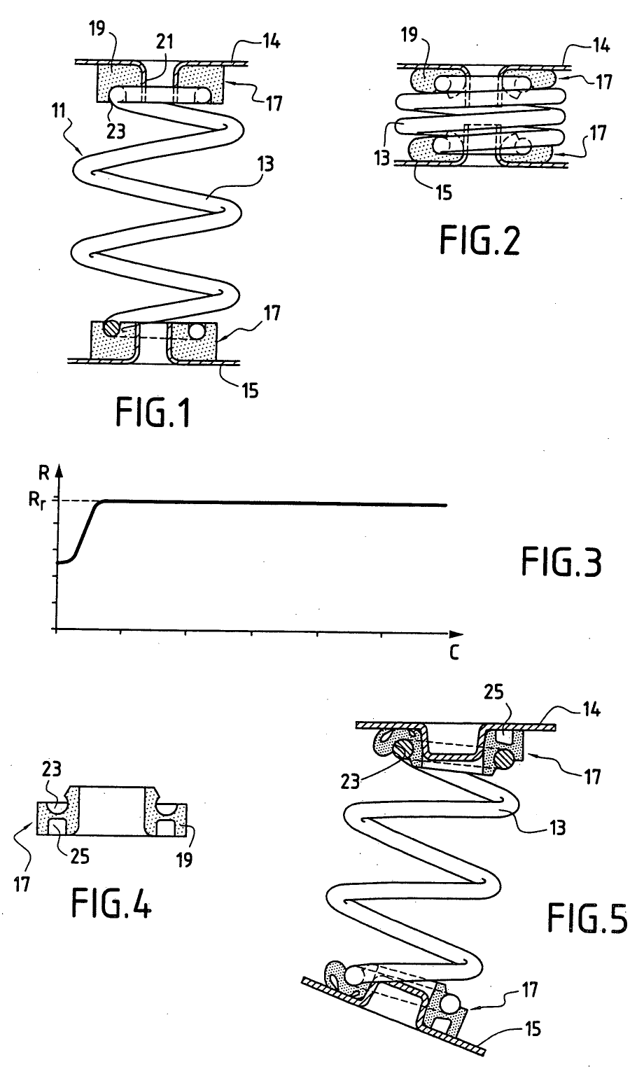

FIG. 1 is a diagram of a portion of a suspension in accordance with the invention, and more particularly of a subassembly including a spring mounted between two supports;

FIG. 2 is a view analogous to FIG. 1, the spring being compressed;

FIG. 3 is a graph showing the stiffness of the subassembly as a function of the compression state thereof;

FIG. 4 is a view of a bushing in a non-stressed state, in one variant; and

FIG. 5 shows a subassembly analogous to that of FIG. 1, in a trailed-arm suspension.

In the drawings, and more particularly in FIGS. 1 and 2, there is shown very diagrammatically a portion of a rear axle suspension for a vehicle, in particular a subassembly 11 comprising a coil spring 13 mounted between two supports 14, 15 of variable spacing.

According to a remarkable characteristic of the invention, at least one of the ends of the spring 13 bears against a corresponding one of said supports 14, 15 via an elastically deformable bushing 17 of variable stiffness and secured to the support. Variation in the stiffness of the bushing must be significant over a portion of the relative displacement between the two supports.

In the example, both supports 14 and 15 are provided with respective ones of such bushings 17.

The variation in the stiffness of the or each bushing must be significant over a fraction of the relative displacement stroke between the two supports, in particular when the coil spring 13 is under light stress, i.e. when it is practically relaxed. In other words, the variable stiffness of the bushings 17 (being flattened to a greater or lesser extent) is used over a range of variation in which said stiffness remains of the same order of magnitude as the mean stiffness of the spring itself, although in this case it is substantially smaller than that. In the example shown, the coil spring 13 is of the constant stiffens type. Very simply, a bushing 17 comprises a thick annular base 19 of elastomer material or the like, that is elastically deformable, i.e. that is capable in particular of being flattened with a variable stiffness characteristic until it reaches a state of maximum compression in which all elasticity disappears. The elastomer material selected and the thickness selected for the elastomer material can serve to determine the variable stiffness characteristic thereof as a function of the extent to which the bushing is flattened. In the present example, and as shown in FIGS. 1 and 2, the base 19 may constitute a simple annular block of compressible elastomer material engaged on a stud projecting from the support, the stud being defined by a plunged boss 21. The bushing is even made as a single piece of such an elastomer material and the corresponding end of said spring comes to bear thereagainst. Preferably, and as shown, the bushing includes an annular groove 23 shaped and dimensioned to receive the corresponding end turn of said spring. The deformation of the bushing can be seen by comparing FIGS. 1 and 2.

FIG. 4 shows a variant of the bushing 17 in which the desired variation in stiffness is also obtained in part by the specific shape of the base. The base includes an annular recess 25 in its thickness, in this case a single annular groove opening out into its face that comes into contact with the support 14 or 15. This groove may be replaced by a series of recesses or cavities that are regularly distributed circumferentially.

In the examples described, the subassembly has two bushings 17, each being interposed between one of the supports 14, 15 and the corresponding end turn of said spring 13.

Under such conditions, and in very general manner, if the stiffness of the spring is Rr and if the stiffnesses of the bushings are respectively R1 and R2, the overall stiffness R of the subassembly 11 is expressed as follows:
R=1/((1/R1)+(1/Rr)+(1/R2))

By selecting appropriate values for Rr, R1, and R2 (as a general rule R1=R2 since the bushings are identical) it is possible to obtain a curve for variation in the overall stiffness of the subassembly 11 as shown in FIG. 3 in which, advantageously, the stiffness R increases over a range corresponding to the suspension being compressed by a small amount C (the spring is practically relaxed, i.e. the wheel is hanging) until it stabilizes on the stiffness Rr of the spring itself (which in this case is constant). The rising curved portion of the curve corresponds to the bushings deforming, while the spring compresses hardly at all because its stiffness is significantly greater than theirs. When the bushings are completely compressed, the stiffness R of the subassembly becomes equivalent to that of the spring, i.e. it becomes constant.

FIG. 4 shows the application of the principle of the invention to a vehicle rear axle suspension in which one of the supports moves relative to the other along a curved trajectory, as for example in a trailed suspension, where the suspension can open to large angles. More precisely, in this example, the support 14 is stationary relative to the vehicle chassis, while the other support 15 is defined on a pivot arm hinged to the same chassis. The invention is particularly advantageous for this type of suspension. In particular, the spring 13 bearing via the two variable-stiffness bushings 17 makes it possible to maintain contact between the end turns of the spring 13 and the bushing 17, and between said bushings and the supports 14, 15 by means of the bushings deforming in non-axially symmetrical manner, in particular in an extreme position with a hanging wheel (as shown in FIG. 5) where the spring is fully relaxed. The deformations of the bushings present the spring becoming detached. In this position, the subassembly 11 maintains some minimum level of loading, due essentially to the compression of the bushings.

Other things remaining equal, this arrangement guarantees acceptable comfort when unloaded and enables a suspension mechanism to be designed that is more compact (smaller height), which constitutes a major advantage when designing the rear axle of a motor vehicle. Conversely, the invention also makes it possible to stiffen the suspension when overloaded.

1-8. (canceled)

9. A vehicle suspension comprising a coil spring mounted between two supports of variable spacing, wherein at least one end of said spring bears against a corresponding one of said supports via an elastically deformable bushing of variable stiffness and presenting significant variation in stiffness, said bushing being secured to the corresponding one of said supports.

10. A suspension according to claim 9, wherein said spring is of constant stiffness.

11. A suspension according to claim 9, wherein said bushing comprises a thick annular base of elastomer material that is elastically deformable.

12. A suspension according to claim 11, wherein said base includes an annular recess.

13. A suspension according to claim 11, wherein said base includes a plurality of recesses that are regularly spaced apart circumferentially.

14. A suspension according to claim 11, wherein said bushing includes an annular groove shaped and dimensioned to receive a corresponding end turn of said spring.

15. A suspension according to claim 11, wherein said bushing is made as a single piece of said elastomer material.

16. A suspension according to claim 11, wherein a said bushing is interposed between each of said supports and a corresponding end turn of said spring.

17. A suspension according to claim 12, wherein said bushing includes an annular groove shaped and dimensioned to receive a corresponding end turn of said spring.

18. A suspension according to claim 12, wherein said bushing is made as a single piece of said elastomer material.

19. A suspension according to claim 13, wherein said bushing is made as a single piece of said elastomer material.

20. A suspension according to claim 14, wherein said bushing is made as a single piece of said elastomer material.

21. A suspension according to claim 12, wherein said bushing is interposed between each of said supports and a corresponding end turn of said spring.

22. A suspension according to claim 13, wherein said bushing is interposed between each of said supports and a corresponding end turn of said spring.

23. A suspension according to claim 14, wherein said bushing is interposed between each of said supports and a corresponding end turn of said spring.

24. A suspension according to claim 15, wherein said bushing is interposed between each of said supports and a corresponding end turn of said spring.
